(19) United States
(12) Patent Application Publication
(10) Pub. No.: US 2002/0145329 A1
(43) Pub. Date: Oct. 10, 2002

(54) Agricultural side dump trailer

(76) Inventor: Layton W. Jensen, Thurston, NE (US)

Correspondence Address: THOMTE, MAZOUR & NIEBERGALL, L.L.C., 2120 S. 72ND STREET, SUITE 1111, OMAHA, NE, 68124, US

(21) Appl. No.: 09/829,359

(22) Filed: Apr. 9, 2001

(51) Int. Cl. B60P 1/04

(52) U.S. Cl. 298/18

(57) ABSTRACT

An agricultural side dump trailer is disclosed comprising an elongated frame having a hitch at its forward end for attachment to the drawbar or three-point hitch of a tractor. A side dump body is pivotally mounted on the trailer frame. The frame is supported by a wheel assembly secured thereto with the wheel assembly being positioned forwardly of the rearward end of the frame so that the load on the tractor hitch is better balanced.

### BACKGROUND OF THE INVENTION

1. Field of the Invention

This invention relates to a side dump trailer and more particularly to a side dump trailer which is ideally suited for agricultural purposes wherein the trailer is connected at its forward end to the drawbar or three-point hitch of a tractor.

2. Description of the Related Art

Dump bodies which are employed on trailers or trucks normally are of the end dump type or the side dump type. Since the introduction of the side dump body disclosed in U.S. Pat. No. 5,480,214, side dump trucks and trailers have experienced wide acceptance. Side dump trailers such as disclosed in U.S. Pat. No. 5,480,214 comprise a side dump body pivotally mounted on a wheeled frame with the forward end of the wheeled frame being supported by the fifth wheel of a truck. Although the side dump trailers such as disclosed in U.S. Pat. No. 5,480,214 work exceptionally well, they are not well-suited to be pulled by an agricultural tractor, since the forward end of the side dump trailer would impose too much weight on the tongue or three-point hitch of the tractor. Further, if the trailer were to tip over, there is a possibility that the trailer could cause the tractor to also turn over.

### SUMMARY OF THE INVENTION

A side dump trailer for agricultural uses is disclosed comprising an elongated frame having a forward end, a rearward end, and opposite sides. A wheel assembly is secured to the frame for supporting the same with the wheel assembly being secured thereto forwardly of the rearward end thereof. An elongated side dump body is movably positioned on the frame and is movable between transport and dumping positions. A hitch is provided at the forward end of the frame for connection to the rearwardly extending tongue of the tractor or to the three-point hitch of the tractor. The hitch preferably includes a horizontally extending swivel pin so that if the trailer tips over the tractor hitch will not be damaged and the tractor will not tip over. The wheel assembly is positioned at approximately the center length of the side dump body to better balance the load for the hitch of the tractor.

It is therefore a principal object of the invention to provide a side dump trailer for agricultural purposes.

Yet another object of the invention is to provide a side dump trailer which may be connected at its forward end to the drawbar or three-point hitch of a tractor.

Still another object of the invention is to provide a side dump trailer for connection to a tractor including means for preventing the tractor from tipping over should the trailer tip over.

Still another object of the invention is to provide a side dump trailer having a hitch at its forward end which is secured to the hitch of the tractor and wherein the frame of the trailer has a wheel assembly mounted thereon with the wheel assembly being positioned at approximately the center of the trailer to better balance the load which is exerted or imposed on the hitch of the tractor.

These and other objects will be apparent to those skilled in the art.

### BRIEF DESCRIPTION OF THE DRAWINGS

FIG. 1 is a front perspective view of the trailer of this invention;

FIG. 2 is a side view of the trailer of this invention; and

FIG. 3 is a perspective view of the hitch at the forward end of the trailer.

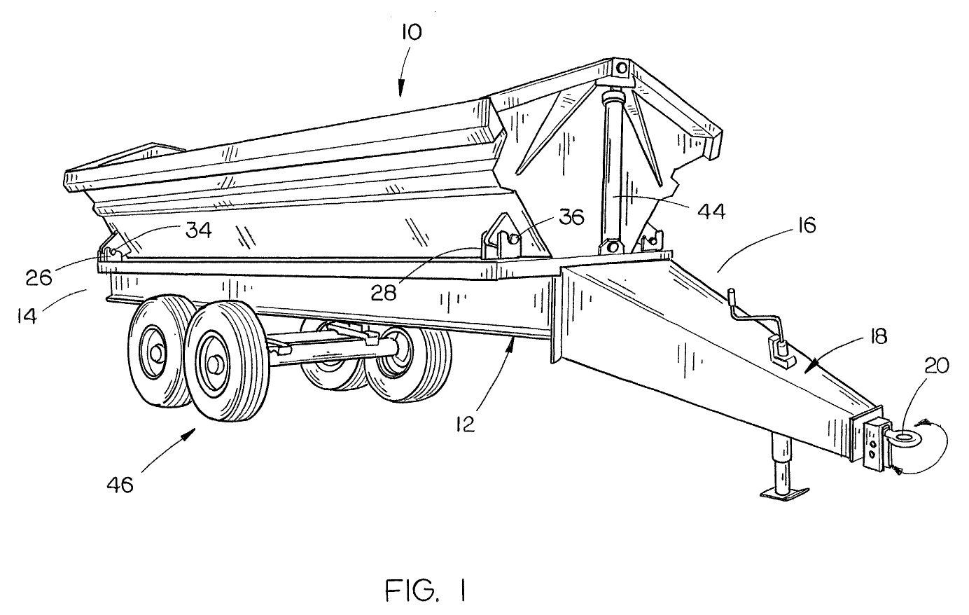

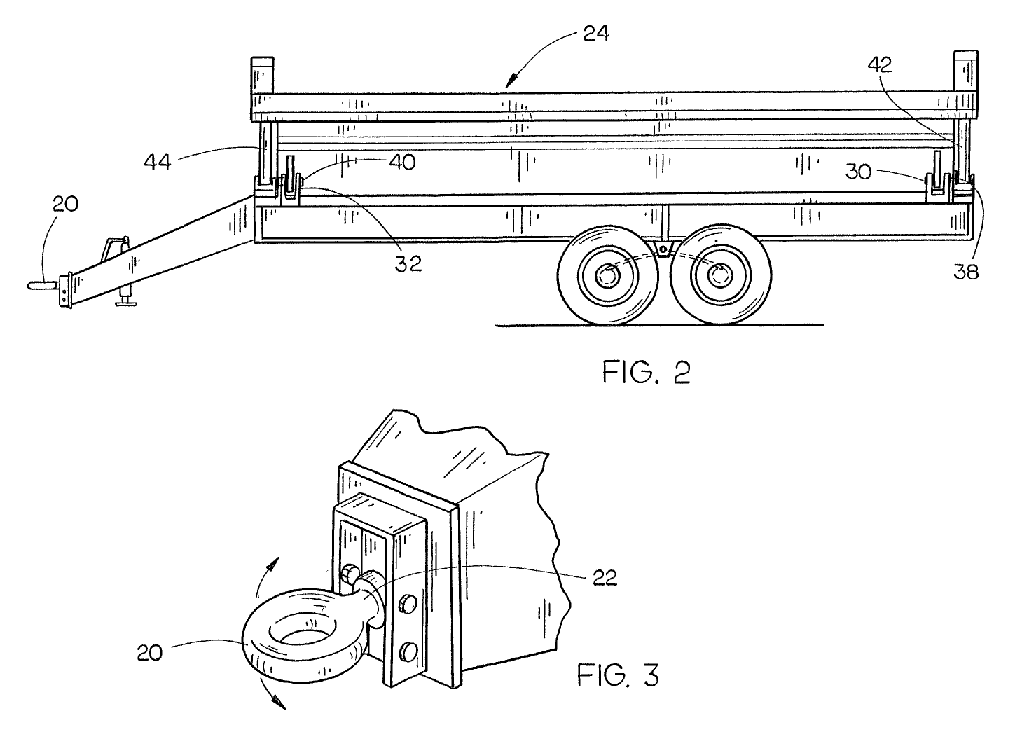

### DESCRIPTION OF THE PREFERRED EMBODIMENT

The side dump trailer of this invention is referred to generally by the reference numeral 10 and is ideally suited for use with a farm tractor so that it may haul grain, manure, etc. Trailer 10 includes an elongated frame 12 having a rearward end 14 and a forward end 16. A downwardly and forwardly extending hitch structure 18 is provided at the forward end of the frame 12 including a hitch 20 at the forward end thereof for connection to the rearwardly extending drawbar of the tractor. Hitch 20 includes a horizontally disposed swivel pin connector 22 which permits the trailer to rotate with respect to the drawbar of the tractor. The swivel pin 22 also enables the tractor and trailer to traverse irregular ground surfaces without undue twisting forces to be imposed in the drawbar of the tractor. The hitch 20 is selectively vertically adjustably mounted on the hitch structure to enable the height of the hitch 20 to be adjusted.

The numeral 24 refers to a side dump body which is pivotally mounted on the frame 12 in generally conventional fashion. Supports 26 and 28 are provided at the rearward and forward ends of the frame 12 at one side thereof while supports 30 and 32 are provided at the rearward and forward ends of the frame 12 at the other side of the frame. Body 24 has a pair of pivot pins 34 and 36 mounted at one side thereof which are adapted to engage supports 26 and 28, respectively, and to pivot thereon when the body 24 is being dumped to the right side of the trailer. The supports 26 and 28 also include locking means for locking the pivot pins 34 and 36 therein. Similarly, pivot pins 38 and 40 are provided at the other side of the body 24 for engagement with the supports 30 and 32, respectively. Hydraulic cylinders 42 and 44 are secured at their base ends to the rearward and forward ends of the frame 12 and have their rod ends pivotally connected to the upper rearward and forward ends of the body 24, respectively. Thus, when the pivot pins 34 and 36 are unlocked from their supports 26 and 28, extension of the cylinders 42 and 44 causes the body 24 to dump to the left with respect to the frame 12. Conversely, when the pivot pins 38 and 40 have been released from the supports 30 and 32, extension of the hydraulic cylinders 42 and 44 causes the body 24 to dump to the right with respect to the trailer.

The numeral 46 refers to a wheel assembly which is the single-point suspension type. The wheel assembly 46 is secured to the frame 12 forwardly of the rearward end and preferably just rearward of the center of the side dump body so that excess weight will not be imposed on the drawbar or three-point hitch of the tractor. The positioning of the wheel assembly also insures that some weight will be placed on the tractor drawbar or three-point hitch. The position of the wheel assembly 46 on the frame 12 also enables the trailer to make sharper turns.

Thus it can be seen that a novel agricultural side dump trailer has been provided which, through the placement of the wheel assembly on the frame, enables the same to be conveniently hitched to a tractor without excessive weight being imposed on the hitch of the tractor. The hitch, through the use of a horizontally disposed swivel pin, also prevents the tractor from overturning should the side dump trailer overturn.

Thus it can be seen that the invention accomplishes at least all of its stated objectives.

I claim:

1. A side dump trailer for agricultural uses, comprising:
an elongated frame having a forward end, a rearward end, and opposite sides;
a wheel assembly secured to said frame for supporting the same;
said wheel assembly being secured to said frame forwardly of the rearward end thereof;
an elongated side dump body movably positioned on said frame;
said side dump body being movable between transport and dumping positions;
and a hitch at the forward end of said frame for connection to a prime mover.

2. The trailer of claim 1 wherein said hitch includes a horizontally disposed swivel connection whereby said frame may rotate with respect to the prime mover.

3. The trailer of claim 2 wherein the prime mover comprises a tractor having a multiple-point hitch at the rearward end thereof to which the hitch of the trailer is connected.

4. The trailer of claim 2 wherein the prime mover comprises a tractor having a horizontally extending drawbar to which the hitch of the trailer is connected.

5. The trailer of claim 2 wherein the prime mover has a horizontally extending drawbar to which the hitch of the trailer is connected.

6. The trailer of claim 1 wherein said wheel assembly is positioned forwardly of the center length of said elongated side dump body to better balance the load for the hitch of the prime mover.

7. The trailer of claim 1 wherein said wheel assembly is positioned just forwardly of the center length of said elongated side dump body.

8. The trailer of claim 7 wherein said wheel assembly is positioned rearwardly of the center length of said elongated side dump body.
